(19) United States
(12) Patent Application Publication
(10) Pub. No.: US 2011/0151224 A1
(43) Pub. Date: Jun. 23, 2011

(54) CELLULOSE FILM AND METHOD FOR PRODUCING THE SAME

(76) Inventors: Seon-Yeong HA, Anyang-si (KR); Jik-Soo SHIN, Seoul (KR); Yong-Won KIM, Seoul (KR); Yu-Jin CHOI, Hwaseong-si (KR)

(21) Appl. No.: 12/768,074

(22) Filed: Apr. 27, 2010

(30) Foreign Application Priority Data
Dec. 23, 2009 (KR) 10-2009-0130174
Dec. 30, 2009 (KR) 10-2009-0133810

(51) Int. Cl. B32B 5/00; B32B 23/00; B32B 5/16; B28B 11/00

(52) U.S. Cl. 428/220; 428/532; 428/323; 428/331; 264/210.1

(57) ABSTRACT

A cellulose film for protecting a polarizing plate of a Liquid Crystal Display Device, and a method for producing the same are disclosed. The cellulose film comprises a front layer which includes a non-phosphoric acid ester type plasticizer; an inner layer which includes a plasticizer and a UV absorbent, and a rear layer which includes a non-phosphoric acid ester type plasticizer and fine particles. Preferably, the front layer further includes fine particles, and the plasticizer in the inner layer includes at least two kinds of plasticizers, and at least one of plasticizer in the inner layer is phosphoric acid ester type plasticizer.

This application claims the priority benefits of Korean Patent Application No. 10-2009-0130174 filed on Dec. 23, 2009 and Korean Patent Application No. 10-2009-0133810 filed on Dec. 30, 2009. All disclosure of the Korean Patent applications is incorporated herein by reference.

### FIELD OF THE INVENTION

This invention relates to a cellulose film and a method for producing the same, and more particularly to a cellulose film for protecting a polarizing plate of a Liquid Crystal Display Device (LCD), and a method for producing the same.

### BACKGROUNDS OF THE INVENTION

Recently, as the demand for portable devices having a LCD increases, the studies for improving the image quality of the LCD and for reducing a production cost have been actively carried out. The LCD is one of the representative flat panel displays that are commercially available. In LCD, the light emitted from a back-light passes through liquid crystal molecules having an anisotropic property and polarizing plates to produce an image. The LCD can be classified into a TN (Twisted nematic)-mode LCD, a VA (Vertical Alignment)-mode LCD and an IPS (In-Plane Switching)-mode LCD. In TN-mode LCD, liquid crystal molecules having a positive (+) dielectric anisotropy are arranged in parallel between a pair of substrates facing each other. In VA-mode LCD, liquid crystal molecules having a negative (−) dielectric anisotropy are arranged in vertical between a pair of substrates facing each other.

In LCD, a cellulose film, such as a triacetyl cellulose film, is attached on a polarizing plate for protecting the polarizing plate. The cellulose film is directly attached on the polarizing plate which displays an image. Thus, the cellulose film should have good optical properties and scratch-resistant surfaces. The cellulose film should also block external UV (Ultra-Violet) rays to prevent degradations of the polarizing plate and liquid crystal molecules. For this purpose, a UV absorbent is contained in the cellulose film. However, the UV absorbent in the cellulose film is liable to be bled out when drying the cellulose film at high temperature, which contaminates the cellulose film. The UV absorbent is also eluted out during alkali saponification step of the polarizing plate, which contaminates the equipments for producing the polarizing plate. The cellulose film may also include a plasticizer, such as phosphoric acid ester, to provide pliability of the cellulose film. However, the plasticizer in the cellulose film is also liable to be bled out when drying the cellulose film at high temperature, and is also eluted out during alkali saponification step of the polarizing plate, which contaminates the cellulose film and the equipments for producing the polarizing plate. For preventing the bleed-out of the plasticizer, non-phosphoric acid ester type plasticizer may be used as the plasticizer. However, the non-phosphoric acid ester type plasticizer is expensive and increases the production cost of the cellulose film.

The cellulose film is generally stored and transported with being rolled on a spool (i.e., in a rolled state). Thus, the rolled and stacked cellulose films may be easily adhered to each other. To prevent the film-adhesion and to provide slipping property to the surface of the film, fine particles are added to the cellulose film, which makes the surface of the film uneven. Meanwhile, as the thickness of the cellulose film becomes thinner to reduce the thickness and weight of a LCD, it becomes more important to control the surface properties of the cellulose film. Thus, in order to improve physical properties of the cellulose film, such as a haze of the film, the kinds, amounts and dispersion state of the additives in the cellulose film should be precisely controlled.

### SUMMARY OF THE INVENTION

Therefore, it is an object of the present invention to provide a cellulose film and a method for producing the same, which can reduce a bleed-out and an elution of a plasticizer and a UV absorbent in the cellulose film and can also prevent degradations of physical properties of the cellulose film.

It is other object of the present invention to provide a cellulose film and a method for producing the same, which can improve a slipping property of the cellulose film by reducing a friction coefficient thereof and improve a dimensional stability of the cellulose film by reducing moisture permeability thereof.

It is another object of the present invention to provide a cellulose film and a method for producing the same, which can prevent formation of a die line on the cellulose film due to scum accumulated on a die lip part.

It is still another object of the present invention to provide a cellulose film which can be easily peeled off from a supporter, and a method for producing the same.

In order to achieve these objects, the present invention provides a cellulose film comprising a front layer which includes a non-phosphoric acid ester type plasticizer, an inner layer which includes a plasticizer and a UV absorbent, and a rear layer which includes a non-phosphoric acid ester type plasticizer and fine particles. Preferably, the front layer further includes fine particles, and the plasticizer in the inner layer includes at least two kinds of plasticizer.

The present invention also provides a method for producing a cellulose film comprising the steps of: i) simultaneously extruding on a belt a first casting solution, a second casting solution and a third casting solution to form a sheet, wherein the first casting solution includes a cellulose resin, a solvent for the cellulose resin and a non-phosphoric acid ester type plasticizer, the second casting solution includes a cellulose resin, a solvent for the cellulose resin, a plasticizer and a UV absorbent, and the third casting solution includes a cellulose resin, a solvent for the cellulose resin, fine particles and a non-phosphoric acid ester type plasticizer; ii) evaporating solvent in the first casting solution, the second casting solution and the third casting solution to form a cellulose film comprising a front layer, an inner layer and a rear layer; iii) peeling off the cellulose film from the belt, and iii) stretching and drying the cellulose film, wherein the front layer includes the non-phosphoric acid ester type plasticizer, the inner layer includes the plasticizer and the UV absorbent and the rear layer includes the non-phosphoric acid ester type plasticizer and fine particles.

Only non-phosphoric acid ester type plasticizer can be used as the plasticizer of the front layer and the rear layer in the present cellulose film, and the inner layer includes a phosphoric acid ester type plasticizer and the UV absorbent. Thus, the bleed-out and the elution of the plasticizer and the UV absorbent can be effectively prevented. In addition, the production cost of the cellulose film decreases and the UV absorbency and pliability of the cellulose film are superior compared with a conventional film using only non-phosphoric acid ester type plasticizer. The hydrophobic fine particles are contained in the rear layer and preferably in the front layer, which decreases the friction coefficient, improve the slipping property, decreases the moisture permeability, and improve the dimensional stability of the cellulose film. Further, the present cellulose film has advantages of suppressing the formation of a die line on the surface thereof and of being easily peeled off from a supporter.

### BRIEF DESCRIPTION OF THE DRAWINGS

FIG. 1 shows an overall apparatus for producing a cellulose film of the present invention.

FIG. 2 is a cross-sectional view of a die and a belt of the apparatus shown in FIG. 1.

FIG. 3 is a cross-sectional view of a cellulose film according to an embodiment of the present invention.

### DETAILED DESCRIPTION OF THE INVENTION

A more complete appreciation of the invention, and many of the attendant advantages thereof, will be better appreciated by reference to the following detailed description.

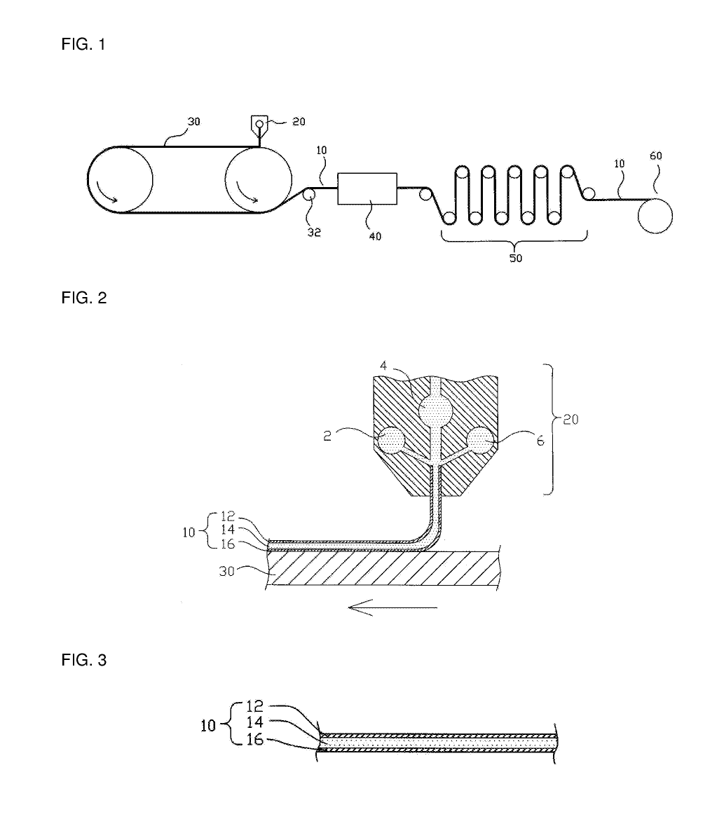

As shown in FIGS. 1 and 2, a cellulose film of the present invention is produced by a solution casting method. In the first step of the method, the first casting solution 2, the second casting solution 4 and the third casting solution 6 are simultaneously extruded through a die 20 on a belt 30 to form a sheet, and the solvents in the casting solutions 2, 4, 6 are evaporated by a high temperature of the belt 30 to form the cellulose film 10. The die 20 is an apparatus for extruding the casting solutions 2, 4, 6 and, for example, a conventional T-die can be used as the die 20. The belt 30 is a supporter for forming the cellulose film 10 by conveying and drying the casting solutions 2, 4, 6. As the belt 30, stainless steel conveyor belt can be used. The thickness of the cellulose film 10 can be controlled by adjusting the moving speed or rotation speed of the belt 30.

The casting solutions 2, 4, 6 extruded from the die 20 are conventionally called as ‘dope’. The first casting solution 2 forms the front layer 12 of the cellulose film 10, the second casting solution 4 forms the inner layer 14 and the third casting solution 6 forms the rear layer 16. The first casting solution 2 includes a cellulose resin, a solvent for dissolving the cellulose resin and a non-phosphoric acid ester type plasticizer for providing imparting pliability to the cellulose film 10. The third casting solution 6 includes a cellulose resin, a solvent for dissolving the cellulose resin, fine particles for reducing the friction coefficient of the cellulose film 10 by making the surface of the cellulose film 10 uneven and a non-phosphoric acid ester type plasticizer for imparting pliability to the cellulose film 10. The second casting solution 4 includes a cellulose resin, a solvent for dissolving the cellulose resin, a UV absorbent for blocking external UV rays and a plasticizer for imparting pliability to the cellulose film 10. Preferably, the first casting solution 2 may further contain fine particles for making the surface of the cellulose film 10 uneven and the second casting solution 4 may contain at least two kinds of plasticizer.

Example of the cellulose resin includes cellulose acetate such as triacetyl cellulose (TAC), cellulose acetate propionate (CAP) or so on. The average substitution degree (acetylation degree) of the cellulose resin is preferably 55 to 66%. As the solvent, a conventional solvent which can dissolve the cellulose resin can be used and for example methylene chloride (MC), methyl acetic acid, or alcohol (for example, methanol) can be used. The cellulose resins and/or the solvents in the first casting solution 2, the second casting solution 4 and the third casting solution 6 may be same or different. The amount of the cellulose resin in each casting solution 2, 4, 6 is conventionally 15 to 25 weight %, preferably 15 to 20 weight %. The amount of the solvent in each casting solution 2, 4, 6 is the remainder except the solid component including the cellulose resin, the plasticizer, the UV absorbent and fine particles.

Example of the fine particles includes a conventional hydrophobic fine particles used in a cellulose film, specifically, silica, titanium dioxide or mixture thereof which has average particle diameter of 0.1 to 2.0 μm, preferably 0.1 to 1.0 μm. If the average diameter of the fine particles is less than 0.1 μm, the friction coefficient of the cellulose films 10 cannot be sufficiently reduced. If the average diameter of the fine particles is more than 2.0 μm, the transparency of the cellulose film 10 can be lowered. The fine particles are contained in the rear layer 16 which contacts the supporter in the casting step of the cellulose film 10, and, if necessary, may be contained in the front layer 12. The amount of the fine particles in the rear layer 16 or the front layer 12 is 0.005 to 2 weight %, preferably 0.01 to 2 weight %, more preferably 0.5 to 2 weight %, most preferably 1 to 1.5 weight %, with respect to the rear layer 16 or the front layer 12. The amount of the fine particles is less than 0.005 weight %, the friction coefficient and moisture permeability of the cellulose film 10 may not be satisfactory. If the amount of the fine particles is more than 2 weight %, the transparency of the cellulose film 10 may be deteriorated.

Example of the UV absorbent includes a conventional UV absorbent used in a cellulose film, specifically, oxybenzophenone compounds, benzotriazole compounds and mixture thereof. The amount of the UV absorbent in the inner layer 14 is 0.5 to 5 weight part, preferably 1 to 5 weight part, more preferably 2 to 3 weight part, with respect to 100 weight part of the cellulose resin in the inner layer 14. If the amount of the UV absorbent is less than 0.5 weight part, the external UV rays may not be sufficiently blocked and if the amount of the UV absorbent is more than 5 weight %, the UV absorbent may be bled out or eluted.

As the plasticizer for the present invention, the non-phosphoric acid ester type plasticizer and/or the phosphoric acid ester type plasticizer are used. The non-phosphoric acid ester type plasticizer can prevent the bleed-out or the elution of the plasticizer during the high-temperature drying step in producing the cellulose film 10, and the example of the plasticizer includes aliphatic polyhydric alcohol ester. The phosphoric acid ester type plasticizer is a plasticizer having a desirable plasticizing property and of low cost, and the example of the plasticizer includes triphenylphosphate, tricresylphosphate, cresyldiphenylphosphate, and so on. The non-phosphoric acid ester type plasticizer and the phosphoric acid ester type plasticizer are commercially available, and, for example, disclosed in International Publication No. WO 2008/129726, the entire content of which is incorporated herein by reference. In the cellulose film 10 of the present invention, the front layer 12 and the rear layer 16 contain only the non-phosphoric acid ester type plasticizer. Meanwhile, the inner layer 14 may contains the non-phosphoric acid ester type plasticizer and/or the phosphoric acid ester type plasticizer. Preferably, the inner layer 14 may contain at least two kinds of plasticizer wherein at least one plasticizer is the phosphoric acid ester type plasticizer. The amount of phosphoric acid ester type plasticizer in the inner layer 14 is preferably 60 weight % or more with respect to the total plasticizer contained in the inner layer 14. If the amount of the phosphoric acid ester type plasticizer is less than the above mentioned range, the pliability of the cellulose film 10 may be degraded.

It is preferable that the non-phosphoric acid ester type plasticizer is uniformly dispersed in the front layer 12 and the rear layer 16. The amount of the non-phosphoric acid ester type plasticizer contained in the front layer 12 or the rear layer 16 is respectively 3 to 40 weight part, preferably 5 to 25 weight part, more preferably 5 to 15 weight part, with respect to 100 weight part of the total plasticizer in the cellulose film 10. The plasticizer amount can be controlled by adjusting thickness of the front layer 12, the inner layer 14 and the rear layer 16 or by adjusting the amount of the respective plasticizer in the first, second and third casting solution 2, 4, 6. If the amount of the non-phosphoric acid ester type plasticizer contained in the front layer 12 or the rear layer 16 respectively is less than 3 weight part, the pliability of the front layer 12 and the rear layer 16 may be deteriorated or the bleed-out or the elution of the plasticizer may not be effectively suppressed. If the amount of the non-phosphoric acid ester type plasticizer in the front layer 12 or the rear layer 16 is more than 40 weight part respectively, the mechanical property of the film 10 may be deteriorated or the production cost for the cellulose film 10 may increase.

In the first or the third casting solution 2, 6, preferably, the amount of the non-phosphoric acid ester type plasticizer is 1 to 20 weight part, preferably 5 to 18 weight part with respect to 100 weight part of the cellulose resin in the first or the third casting solution 2, 6. If the amount of the non-phosphoric acid ester type plasticizer is less than the above mentioned range, the pliability of the front layer 12 or the rear layer 16 may be degraded or the bleed-out or the elution of the plasticizer may not be effectively suppressed. If the amount of the non-phosphoric acid ester type plasticizer is more than the above mentioned range, the mechanical property of the film 10 may be deteriorated or the production cost for the cellulose film 10 may increase. The amount of the plasticizer contained in the inner layer 14, that is, the second casting solution 4 is 1 to 20 weight part, preferably 5 to 18 weight part, more preferably 10 to 17 weight part, with respect to 100 weight part of the cellulose resin in the inner layer 14. If the amount of the plasticizer in the inner layer 14 is less than the above mentioned range, the pliability of the cellulose film 10 may be degraded and if the amount of the plasticizer in the inner layer 14 is more than the above mentioned range, the plasticizer may be bled out.

For producing the cellulose film 10 of the present invention, the cellulose resin, the solvent, the UV absorbent, fine particles and/or the plasticizer are introduced to and mixed in the respective pipe 22, 24, 26 which forms the casting solution 2, 4, 6 and layers 12, 14, 16 as shown in FIG. 2. Namely, the respective components are side-fed in the respective pipe 22, 24, 26. Here, the front layer 12 and the rear layer 16 contain the non-phosphoric acid ester type plasticizer and/or fine particles and the inner layer 14 contains the plasticizer and the UV absorbent. The thickness of the cellulose film 10 (the film thickness after the stretching and drying step) is generally 20 to 100 μm, preferably 40 to 80 μm, and the respective thickness of the front layer 12 and the rear layer 16 is 5 to 33.3%, preferably 5 to 20%, more preferably 8 to 12%, with respect to the total thickness of the cellulose film 10. The thickness of the inner layer 14 is preferably 60 to 90%, more preferably 76 to 84% with respect to the total thickness of the cellulose film 10. If the thickness of the front layer 12, the inner layer 14 and the rear layer 16 deviates from the above-mentioned ranges, the physical property of the cellulose film 10, such as pliability, may be degraded or the bleed-out of the plasticizer and the UV absorbent may happen.

Returning to FIG. 1, the casting solutions 2, 4, 6 coated on the belt 30 travel with the belt 30 for a predetermined time and distance that are enough to form the cellulose film 10, and then the cellulose film 10 is peeled off from the belt 30 by a peel-off roller 32 which is a guide roller. The peeled film 10 is conveyed to a tenter 40, is stretched in a transverse direction (TD) and/or in a mechanical direction (MD) and then is dried at a drier 50, to form a final cellulose film 10. The final cellulose film 10 is wound by a winder 60 to be commercial products.

FIG. 3 is a cross sectional view of the cellulose film according to an embodiment of the present invention. As shown in FIG. 3, the cellulose film 10 of the present invention has a multi-layer structure, preferably three-layer-structure of the front layer 12, the inner layer 14 and the rear layer 16. For the cellulose film 10 of the present invention, the degree of the bleed-out of the plasticizer at the surface of the cellulose film 10 is examined with a gas chromatography (GC). Only less than 10%, preferably 1 to 8%, more preferably 1 to 5% of the total plasticizer is bled out at the surface of the cellulose film 10. In the cellulose film 10, the fine particles in the rear layer 16 reduce the friction coefficient of the cellulose film 10, and improve the slipping property of the film 10. In the cellulose film 10 of the present invention, as the amount of the total fine particles is relatively small, the haze of the cellulose film 10 can be maintained to be low. Thus, the haze of the cellulose film 10 of the present invention is generally 0 to 0.4%, and the dynamic coefficient of friction (coefficient of kinetic friction) is generally 0.4 to 0.7. When the fine particles are included only in the rear layer 16 which contacts the supporter 30 in the casting process, the peeling-off of the cellulose film 10 from the supporter 30 can be easily carried out. Also the die line caused by scum which is derived from the accumulation of fine particle agglutination in the front layer 12 may be suppressed.

The cellulose film 10 of the present invention is typically attached to one side or both sides of a polarizing plate of polyvinyl alcohol (PVA) to protect the polarizing plate. The polarizing plate having the cellulose film 10 is mounted on an upper substrate and/or a lower substrate of a LCD panel. If necessary, the cellulose film 10 may be positioned on the polarizing plate with a predetermined gap.

Hereinafter, the preferable examples and comparative example are provided for better understanding of the present invention. However, the present invention is not limited by the following examples.

### Example 1

### Production and Evaluation of Cellulose Film

The first casting solution 2, the second casting solution 4 and the third casting solution 6 were prepared. The first casting solution 2 included 18 weight part of triacetyl cellulose (TAC) as a cellulose resin, 81.76 weight part of methylene chloride (MC) as a solvent for dissolving the cellulose resin and 0.2 weight part of aliphatic polyhydric alcohol ester as a non-phosphoric acid ester type plasticizer. The second casting solution 4 included 15.84 weight part of TAC, 81.76 weight part of MC, 1.4 weight part of the phosphoric acid ester type plasticizer (triphenylphosphate) and 0.2 weight part of aliphatic polyhydric alcohol ester as plasticizers, and 0.25 weight parts of benzotriazole compound as a UV absorbent. The third casting solution 6 included 18 weight part of TAC, 81.76 weight part of MC, 0.2 weight part of aliphatic polyhydric alcohol ester as a non-phosphoric acid ester type plasticizer and 0.002 weight part of silica having the diameter of 0.1 to 1 μm as fine particles. By using the die 20 shown in FIG. 2 the first casting solution 2, the second casting solution 4 and the third casting solution 6 were simultaneously extruded on a metal belt 30 to coat the surface of the metal belt 30 and form a sheet having a thickness of 90 μm and a width of 800 mm. The produced cellulose film 10 had a front layer 12, an inner layer 14 and a rear layer 16. As shown in FIG. 1, the solvents in the casting solutions 2, 4, 6 were evaporated while the metal belt 30 was moved, and the stretching and drying process were carried out to produce the cellulose film 10 having the thickness of 80 μm. The thicknesses of the front layer 12, the inner layer 14 and the rear layer 16 were about 33.3% of the total thickness of the cellulose film 10. From the evaluations of the produced cellulose film 10, it was revealed that the amount of the plasticizer which was bled out at the surface of the cellulose film 10 is less than 8 weight %, the amount of the UV absorbent which was bled out at the surface of the film 10 is less than 5 weight %. The UV transmittance of the film 10 was less than 5%, the haze of the film 10 was 0.2%, and the friction coefficient of the film 10 was less than 0.7. Also, die line is not formed at the surface of the cellulose film 10.

### Example 2

### Production and Evaluation of Cellulose Film

The first and third casting solutions 2, 6 for producing the front layer 12 and the rear layer 16 of the cellulose film 10 were prepared by 18 weight part of TAC, 81.76 weight part of MC and 0.2 weight part of aliphatic polyhydric alcohol ester as a plasticizer and 0.002 weight part of fine particles. The second casting solution 4 for producing the inner layer 14 of the film 10 was prepared by using 15.84 weight part of TAC, 81.76 weight part of MC, 1.4 weight % of the phosphoric acid ester plasticizer (triphenylphosphate, tricresylphosphate or cresyl-diphenylphosphate) and 0.2 weight part of aliphatic polyhydric alcohol ester as a plasticizer, and 0.25 weight part of benzotriazole compounds as a UV absorbent. By using the die 20 in FIG. 2, each of the first casting solution 2, the second casting solution 4 and the third casting solution 6 was casted into the surface of a metal belt 30 to form a sheet having the thickness of 90 μm and the width of 800 mm. The solvents in the casting solutions 2, 4, 6 were evaporated while the metal belt 30 was moved, and the stretching and drying process were carried out to produce the cellulose film 10 having the thickness of 80 μm. The thicknesses of the front layer 12 and the rear layer 16 were about 5 to 20% of the total thickness of the cellulose film 10. The amount of the non-phosphoric acid ester type plasticizer contained in the front layer 12 and the rear layer 16 is respectively 7 weight part with respect to 100 weight part of the total plasticizer in the cellulose film 10. From gas chromatography (GC) evaluations, it was revealed that the amount of the plasticizer which was bled out at the surface of the cellulose film 10 is less than 8 weight %, the amount of the UV absorbent which was bled out at the surface of the film 10 is less than weight %. The UV transmittance of the film 10 was less than 5%, the haze of the film 10 was 0.3%, and the friction coefficient of the film 10 was less than 0.7.

### Examples 3-4, Comparative Example

### Production and Evaluation of Cellulose Film

Except for using the non-phosphoric acid ester type plasticizer, the phosphoric acid ester type plasticizer, the UV absorbent and the fine particles in the front layer 12, the inner layer 14 and the rear layer 16 with the amounts shown in Table 1, the cellulose film 10 was produced according to the method of Example 1. In Table 1, the amount of each component represents an amount with respect to the weight of each layer 12, 14 or 16.

TABLE 1

| | Comparative Example | Example 3 | Example 4 |
|---|---|---|---|
| Front | 10 wt % of phosphoric acid ester | 5 wt % of non-phosphoric | 7 wt % of non-phosphoric |
| layer | plasticizer, 2 wt % of | acid ester type plasticizer | acid ester type plasticizer |
| 12 | non-phosphoric acid ester type | | |
| | plasticizer, and 1 wt % of fine | | |
| | particles | | |
| Inner | 12 wt % of phosphoric acid ester | 10 wt % of phosphoric acid | 10 wt % of phosphoric |
| layer | plasticizer, and | ester plasticizer, and 0.5 wt | acid ester plasticizer, and |
| 14 | 0.5 wt % of UV absorbent | % of UV absorbent | 0.5 wt % of UV absorbent |
| Rear | 10 wt % of phosphoric acid ester | 5 wt % of non-phosphoric | 7 wt % of non-phosphoric |
| layer | plasticizer, 2 wt % of | acid ester type plasticizer, | acid ester type plasticizer, |
| 16 | non-phosphoric acid ester type | and 1.3 wt % of fine | and 1 wt % of fine |
| | plasticizer, and 1 wt % of fine | particles | particles |
| | particles | | |

The friction coefficient, haze, number of die line, peeling-off strength, dimensional stability at high humidity of the cellulose film 10 were measured and the results are shown in Table 2. The haze of the cellulose film 10 was measured with a hazemeter of Nippon Denshoku Industries Co., Ltd. (Japan), and the number of die line formed on the cellulose film 10 was measured with naked eyes under xenon lamp in a darkroom. The peeling-off strength was measured with a push-pull gauge (load cell) of DACELL Co., Ltd. (Korea), and the dimensional stability at high humidity was measured with a dial gauge after placing the cellulose film 10 for 30 minutes at 60° C., 95% humidity.

TABLE 2

| | Comparative Example | Example 3 | Example 4 |
|---|---|---|---|
| Friction coefficient | 0.5 | 0.6 | 0.7 |
| Haze | 0.4 | 0.3 | 0.2 |
| Number of die line | 4 | 2 | 1 |
| Peeling-off strength | 5 Kgf | 5 Kgf | 6 Kgf |
| Dimensional stability | 0.15% | 0.10% | 0.08% |
| at high humidity | | | |

As shown in Table 2, the cellulose film of the present invention has good physical properties, such as the friction coefficient, the haze, the die line, the peeling-off strength and the dimensional stability at high humidity.

1. A cellulose film comprising:
a front layer which includes a non-phosphoric acid ester type plasticizer;
an inner layer which includes a plasticizer and a UV absorbent, and
a rear layer which includes a non-phosphoric acid ester type plasticizer and fine particles.

2. The cellulose film of claim 1, wherein the front layer further includes fine particles.

3. The cellulose film of claim 1, wherein the plasticizer in the inner layer includes at least two kinds of plasticizers which are selected from phosphoric acid ester type plasticizer and/or non-phosphoric acid ester type plasticizer.

4. The cellulose film of claim 3, wherein at least one of plasticizer among at least two kinds of plasticizers in the inner layer is phosphoric acid ester type plasticizer.

5. The cellulose film of claim 1, wherein the UV absorbent is selected from a group consisting of oxybenzophenone compounds, benzotriazole compounds and mixture thereof.

6. The cellulose film of claim 3, wherein the phosphoric acid ester type plasticizer is selected from a group consisting of triphenylphosphate, tricresylphosphate, cresyldiphenylphosphate and mixture thereof.

7. The cellulose film of claim 1, wherein the non-phosphoric acid ester type plasticizer is aliphatic polyhydric alcohol ester.

8. The cellulose film of claim 1, wherein the amount of the non-phosphoric acid ester type plasticizer in the front layer and the rear layer is respectively 3 to 40 weight part with respect to 100 weight part of the total plasticizer in the cellulose film.

9. The cellulose film of claim 1, wherein the fine particle is selected from the group consisting of silica, titanium dioxide and mixture thereof, the average particle diameter of the fine particle is 0.1 to 2.0 μm.

10. The cellulose film of claim 1, wherein the amount of the fine particle in the rear layer is 0.005 to 2 weight % with respect to the total weight of the rear layer.

11. The cellulose film of claim 1, wherein the total thickness of the cellulose film is 20 to 100 μm and the thickness of the front layer or the rear layer is 5 to 20% with respect to the total thickness of the cellulose film.

12. The cellulose film of claim 1, wherein haze of the cellulose film is 0 to 0.4%, dynamic coefficient of friction is 0.4 to 0.7.

13. The cellulose film of claim 1, wherein the amount of the plasticizer which is bled out at the surface of the cellulose film is less than 10% with respect to the total plasticizer in the cellulose film.

14. A method for producing a cellulose film, comprising the steps of:
i) simultaneously extruding on a belt a first casting solution, a second casting solution and a third casting solution to form a sheet, wherein the first casting solution includes a cellulose resin, a solvent for the cellulose resin and a non-phosphoric acid ester type plasticizer, the second casting solution includes a cellulose resin, a solvent for the cellulose resin, a plasticizer and a UV absorbent, and the third casting solution includes a cellulose resin, a solvent for the cellulose resin, fine particles and a non-phosphoric acid ester type plasticizer;
ii) evaporating solvent in the first casting solution, the second casting solution and the third casting solution to form a cellulose film comprising a front layer, an inner layer and a rear layer;
iii) peeling off the cellulose film from the belt, and
iii) stretching and drying the cellulose film,
wherein the front layer includes the non-phosphoric acid ester type plasticizer, the inner layer includes the plasticizer and the UV absorbent and the rear layer includes the non-phosphoric acid ester type plasticizer and fine particles.
